(19) United States
(12) Patent Application Publication
(10) Pub. No.: US 2010/0073322 A1
(43) Pub. Date: Mar. 25, 2010

(54) Desktop computer

(75) Inventors: Kai-Li Jiang, Beijing (CN); Qun-Qing Li, Beijing (CN); Shou-Shan Fan, Beijing (CN)

Correspondence Address: PCE INDUSTRY, INC.;ATT. Steven Reiss, 288 SOUTH MAYO AVENUE, CITY OF INDUSTRY, CA, 91789, US

(73) Assignees: Tsinghua University, Beijing (CN); HON HAI Precision Industry CO., LTD., Tu-Cheng City (TW)

(21) Appl. No.: 12/459,557

(22) Filed: Jul. 2, 2009

(30) Foreign Application Priority Data
Sep. 19, 2008 (CN) 200810216309.9

(51) Int. Cl. G06F 3/044; G06F 3/041

(52) U.S. Cl. 345/174; 345/173; 977/742; 977/932

(57) ABSTRACT

A desktop computer includes a body, a display and a touch panel. The display is connected to the body by a data wire. The display includes a display screen. The touch panel includes at least one transparent conductive layer including a carbon nanotube structure.

### RELATED APPLICATIONS

This application is related to copending applications entitled, “TOUCH PANEL”, U.S. application Ser. No. 12/286,266, filed Sep. 29, 2008; “TOUCH PANEL”, U.S. application Ser. No. 12/286,141, filed Sep. 29, 2008; “TOUCH PANEL AND DISPLAY DEVICE USING THE SAME”, U.S. application Ser. No. 12/286,189, filed Sep. 29, 2008; “TOUCH PANEL AND DISPLAY DEVICE USING THE SAME”, U.S. application Ser. No. 12/286,181, filed Sep. 29, 2008; “TOUCH PANEL AND DISPLAY DEVICE USING THE SAME”, U.S. application Ser. No. 12/286,176, filed Sep. 29, 2008; “TOUCH PANEL AND DISPLAY DEVICE USING THE SAME”, U.S. application Ser. No. 12/286,166, filed Sep. 29, 2008; “TOUCH PANEL AND DISPLAY DEVICE USING THE SAME”, U.S. application Ser. No. 12/286,178, filed Sep. 29, 2008; “TOUCH PANEL AND DISPLAY DEVICE USING THE SAME”, U.S. application Ser. No. 12/286,148, filed Sep. 29, 2008; “TOUCHABLE CONTROL DEVICE”, U.S. application Ser. No. 12/286,140, filed Sep. 29, 2008; “TOUCH PANEL AND DISPLAY DEVICE USING THE SAME”, U.S. application Ser. No. 12/286,154, filed Sep. 29, 2008; “TOUCH PANEL AND DISPLAY DEVICE USING THE SAME”, U.S. application Ser. No. 12/286,216, filed Sep. 29, 2008; “TOUCH PANEL AND DISPLAY DEVICE USING THE SAME”, U.S. application Ser. No. 12/286,152, filed Sep. 29, 2008; “TOUCH PANEL AND DISPLAY DEVICE USING THE SAME”, U.S. application Ser. No. 12/286,146, filed Sep. 29, 2008; “TOUCH PANEL AND DISPLAY DEVICE USING THE SAME”, U.S. application Ser. No. 12/286,145, filed Sep. 29, 2008; “TOUCH PANEL, METHOD FOR MAKING THE SAME, AND DISPLAY DEVICE ADOPTING THE SAME”, U.S. application Ser. No. 12/286,155, filed Sep. 29, 2008; “TOUCH PANEL AND DISPLAY DEVICE USING THE SAME”, U.S. application Ser. No. 12/286,179, filed Sep. 29, 2008; “TOUCH PANEL, METHOD FOR MAKING THE SAME, AND DISPLAY DEVICE ADOPTING THE SAME”, U.S. application Ser. No. 12/286,228, filed Sep. 29, 2008; “TOUCH PANEL AND DISPLAY DEVICE USING THE SAME”, U.S. application Ser. No. 12/286,153, filed Sep. 29, 2008; “TOUCH PANEL AND DISPLAY DEVICE USING THE SAME”, U.S. application Ser. No. 12/286,184, filed Sep. 29, 2008; “METHOD FOR MAKING TOUCH PANEL”, U.S. application Ser. No. 12/286,175, filed Sep. 29, 2008; “METHOD FOR MAKING TOUCH PANEL”, U.S. application Ser. No. 12/286,195, filed Sep. 29, 2008; “TOUCH PANEL AND DISPLAY DEVICE USING THE SAME”, U.S. application Ser. No. 12/286,160, filed Sep. 29, 2008; “TOUCH PANEL AND DISPLAY DEVICE USING THE SAME”, U.S. application Ser. No. 12/286,220, filed Sep. 29, 2008; “TOUCH PANEL AND DISPLAY DEVICE USING THE SAME”, U.S. application Ser. No. 12/286,227, filed Sep. 29, 2008; “TOUCH PANEL AND DISPLAY DEVICE USING THE SAME”, U.S. application Ser. No. 12/286,144, filed Sep. 29, 2008; “TOUCH PANEL AND DISPLAY DEVICE USING THE SAME”, U.S. application Ser. No. 12/286,218, filed Sep. 29, 2008; “TOUCH PANEL AND DISPLAY DEVICE USING THE SAME”, U.S. application Ser. No. 12/286,1428, filed Sep. 29, 2008; “TOUCH PANEL AND DISPLAY DEVICE USING THE SAME”, U.S. application Ser. No. 12/286,241, filed Sep. 29, 2008; “TOUCH PANEL, METHOD FOR MAKING THE SAME, AND DISPLAY DEVICE ADOPTING THE SAME”, U.S. application Ser. No. 12/286,151, filed Sep. 29, 2008; “ELECTRONIC ELEMENT HAVING CARBON NANOTUBES”, U.S. application Ser. No. 12/286,143, filed Sep. 29, 2008; TOUCH PANEL, METHOD FOR MAKING THE SAME, AND DISPLAY DEVICE ADOPTING THE SAME”, U.S. application Ser. No. 12/286,219, filed Sep. 29, 2008; and “PERSONAL DIGITAL ASSISTANT”, U.S. application Ser. No. 12/384,329, filed Apr. 2, 2009.

### BACKGROUND

1. Technical Filed

The present disclosure relates to desktop computers and, particularly, to a carbon nanotube based desktop computer.

2. Discussion of Related Art

A typical desktop computer includes a body, a display, and a touch panel. The display is connected to the body by a data wire. The display has a display screen, and the touch panel is located on the display screen. Different types of touch panels, including resistance, capacitance, infrared, and surface sound-wave types have been developed. Due to their high accuracy and low cost of production, resistance-type and capacitance-type touch panels have been widely used in desktop computers.

Conventional resistance-type and capacitance-type touch panels employ conductive indium tin oxide (ITO) as transparent conductive layers. ITO layers are generally formed by the complicated mean of ion-beam sputtering. Additionally, ITO layers have poor wearability/durability, low chemical endurance, and cause uneven resistance across the touch panels. Thus, desktop computers using touch panels employing ITO will have low sensitivity and short lifetime.

What is needed, therefore, is a desktop computer in which the above problems are eliminated or at least alleviated.

### BRIEF DESCRIPTION OF THE DRAWINGS

Many aspects of the present desktop computer can be better understood with references to the following drawings. The components in the drawings are not necessarily drawn to scale, the emphasis instead being placed upon clearly illustrating the principles of the present desktop computer.

FIG. 1 is a schematic view of a desktop computer in accordance with a first embodiment.

FIG. 2 is an exploded, isometric view of a touch panel in the desktop computer of FIG. 1.

FIG. 3 cross-sectional view of the touch panel of FIG. 2 once assembled.

FIG. 4 is a Scanning Electron Microscope (SEM) image of a carbon nanotube film that can be utilized in the desktop computer.

FIG. 5 is a schematic structural view of a carbon nanotube segment.

FIG. 6 is a schematic cross-sectional view of the touch panel of the first embodiment used with a display screen, showing operation of the touch panel with a touch tool.

FIG. 7 is a schematic view of a desktop computer in accordance with a second embodiment employing a capacitance-type touch panel.

FIG. 8 is an exploded, isometric top view of a touch panel in the desktop computer according to a second embodiment.

FIG. 9 is a cross-sectional view of the touch panel of FIG. 8 taken along a line of VII-VII

FIG. 10 is a schematic cross-sectional view of the touch panel of the second embodiment used with a display screen, showing operation of the touch panel.

Corresponding reference characters indicate corresponding parts throughout the several views. The examples set out herein illustrate at least one embodiment of the present desktop computer, in at least one form, and such examples are not to be construed as limiting the scope of the invention in any manner.

### DETAILED DESCRIPTION OF EXEMPLARY EMBODIMENTS

References will now be made to the drawings to describe, in detail, embodiments of the present desktop computer.

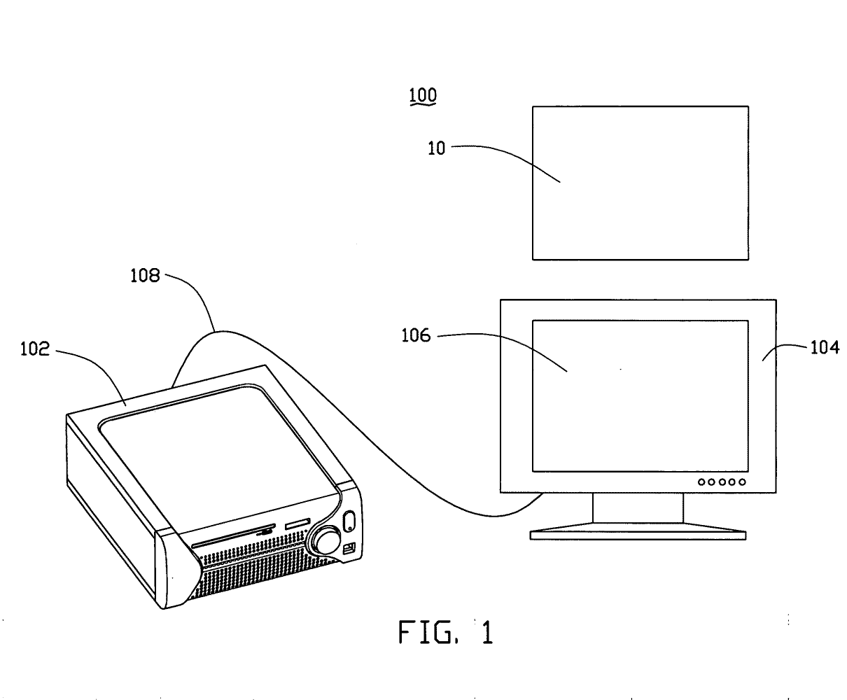

Referring to FIG. 1, a desktop computer 100 in accordance with a first embodiment is provided. The desktop computer 100 includes a body 102, a display 104, and a touch panel 10.

The display 104 is connected to the body 102 by a data wire. The display 104 has a display screen 106. The touch panel 10 is adjacent to the display screen 106. In one embodiment, the touch panel 10 is located on the display screen 106. It can be understood that the touch panel 10 also can be connected to the display 104 and the body 102 by data wires. The touch panel 10 and the display 104 can be separately located on a same supporter or different supporters.

The body 102 includes a mainboard, a central processing unit (CPU), a memory, hard drive components and so on. The mainboard includes a system bus, a data bus, a control bus, a variety of slots, and other components. The CPU, memory, graphics cards, sound cards, network cards, and video cards are inserted in the mainboard. The hard drive components are electrically connected to the mainboard by a cable. The body 102 further includes a touch panel control element connected to the touch panel and a display control element connected to the display. The touch panel control element and the display control element are electrically connected to the CPU. The CPU accepts the coordinates of a touch point output from the touch panel control element, and processes the coordinates of the touch point. The CPU sends out commands corresponding to the touch point to the display control element and the display control element further controls the display of the display screen 106. At least two of the external input/output ports (not shown) can be located at one terminal of the body 102 and used to connect to the display 104, the touch panel 10 and other devices. Further, a speaker (not labeled) and disk drives (not labeled) can be located on a side of the body 102.

The display 104 can be selected from a group consisting of liquid crystal display, field emission display, plasma display, electroluminescent display and vacuum fluorescent display. The display 104 is used to display output data and images of the body 102. In the present embodiment, the display 104 is a liquid crystal display.

The touch panel 10 is configured for inputting signals. The signals can be command signals or text signals. The touch panel 10 can replace the conventional inputting means, such as a mouse and a keyboard. The touch panel 10 can be spaced from the display screen 106 or installed directly on the display screen 106. When the touch panel 10 is installed directly on the display screen 106, the touch panel 10 can be adhered on the display screen 106 by an adhesive or the touch panel 10 and the display screen 106 can be integrated, such as by using a same base. In the present embodiment, the touch panel 10 is installed directly on the display screen 106. Further, a keyboard (not shown) also can be displayed on the display screen 106, a mouse and a keyboard also can be provided to supplement or diversify the input means.

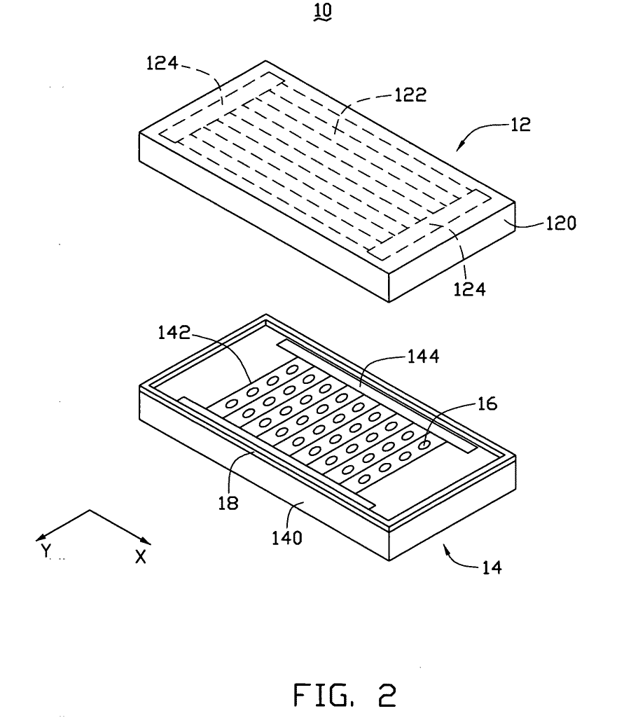

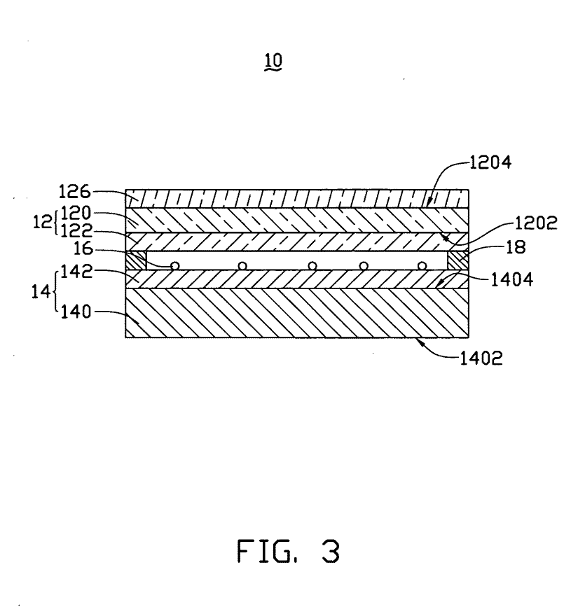

Referring to FIGS. 2 and 3, the touch panel 10 of the desktop computer 100 according to the first embodiment is a resistance-type touch panel. The touch panel 10 includes a first electrode plate 12, a second electrode plate 14, and a plurality of dot spacers 16 located between the first electrode plate 12 and the second electrode plate 14.

The first electrode plate 12 includes a first substrate 120, a first transparent conductive layer 122, and two first-electrodes 124. The first substrate 120 includes a first surface 1202 and a second surface 1204, each of which is substantially flat. The two first-electrodes 124 and the first transparent conductive layer 122 are located on the first surface 1202 of the first substrate 120. The two first-electrodes 124 are located separately on opposite ends of the first transparent conductive layer 122. A direction from one of the first-electrodes 124 across the first transparent conductive layer 122 to the other first electrode 124 is defined as a first direction. The two first-electrodes 124 are electrically connected to the first transparent conductive layer 122.

The second electrode plate 14 includes a second substrate 140 as a support structure for a second transparent conductive layer 142, and two second-electrodes 144. The second substrate 140 includes a first surface 1402 and a second surface 1404, each of which is substantially flat. The two second-electrodes 144 and a second transparent conductive layer 142 are located on the second surface 1404 of the second substrate 140. The two second-electrodes 144 are located separately on opposite ends of the second transparent conductive layer 142. A direction from one of the second-electrodes 144 across the second transparent conductive layer 142 to the other second-electrodes 144 is defined as a second direction, which is perpendicular to the first direction. The two second-electrodes 144 are electrically connected to the second transparent conductive layer 142. It is understood that when the touch panel 10 and the display screen 106 use a same base, the second transparent conductive layer 142 can be formed on a surface of the display screen 106 directly, and the second substrate 140 can be omitted.

The first substrate 120 is a transparent and flexible film or plate. The second substrate 140 is a transparent plate. The first-electrodes 124 and the second-electrodes 144 can be made of metal or any other suitable material. In the present embodiment, the first substrate 120 is a polyester film, the second substrate 140 is a glass plate, and the first-electrodes 124 and second-electrodes 144 are made of a conductive silver paste.

An insulative layer 18 is provided between the first and the second electrode plates 12 and 14. The first electrode plate 12 is located on the insulative layer 18. The first transparent conductive layer 122 is opposite to, but is spaced from, the second transparent conductive layer 142. The dot spacers 16 are separately located on the second transparent conductive layer 142. A distance between the second electrode plate 14 and the first electrode plate 12 can be in a range from about 2 to about 20 microns. The insulative layer 18 and the dot spacers 16 are made of, for example, insulative resin or any other suitable insulative material. Therefore, insulation between the first electrode plate 12 and the second electrode plate 14 is provided by the insulative layer 18 and the dot spacers 16. It is to be understood that the dot spacers 16 are optional, particularly when the touch panel 10 is relatively small. They serve as supports given the size of the span and the strength of the first electrode plate 12 and can be employed when needed.

A transparent protective film 126 is located on the second surface 1204 of the first substrate 120 of the first electrode plate 12. The material of the transparent protective film 126 can be selected from a group consisting of silicon nitrides, silicon dioxides, benzocyclobutenes, polyester films, and polyethylene terephthalates. The transparent protective film 126 can be made of slick plastic and receive a surface hardening treatment to protect the first electrode plate 12 from being scratched when in use.

At least one of the first transparent conductive layer 122 and the second transparent conductive layer 142 includes a carbon nanotube structure. The carbon nanotube structure is substantially uniform in thickness and includes a plurality of carbon nanotubes uniformly distributed therein. The carbon nanotubes therein are orderly or disorderly distributed. The term ‘disordered carbon nanotube structure’ includes a structure where the carbon nanotubes are arranged along many different directions, arranged such that the number of carbon nanotubes arranged along each different direction can be almost the same (e.g. uniformly disordered); and/or entangled with each other. ‘Ordered carbon nanotube structure’ includes a structure where the carbon nanotubes are arranged in a consistently systematic manner, e.g., the carbon nanotubes are arranged approximately along a same direction and or have two or more sections within each of which the carbon nanotubes are arranged approximately along a same direction (different sections can have different directions). In one embodiment, the carbon nanotube structure consists of substantially pure carbon nanotubes.

The carbon nanotube structure includes at least one carbon nanotube film. The carbon nanotube film can be an ordered film or a disordered film. In the disordered film, the carbon nanotubes are disordered. The disordered film can be isotropic. The disordered carbon nanotubes are entangled with each other and/or attracted by van der Waals attractive therebetween. The carbon nanotubes can be substantially parallel to a surface of the carbon nanotube film. In the ordered film, the carbon nanotubes are primarily oriented along a same direction. Alternatively, the carbon nanotube structure can include at least two carbon nanotube films that overlap and/or stacked with each other. An angle between the aligned directions of the carbon nanotubes in the two adjacent ordered carbon nanotube films ranges from more than or equal to 0 degrees to less than or equal to 90 degrees. The carbon nanotube structure also can include a plurality of coplanar carbon nanotube films. The plurality of coplanar carbon nanotube films can form a large area to make a large area touch panel. Carbon nanotubes in the carbon nanotube structure can be selected from a group consisting of single-walled, double-walled, and/or multi-walled carbon nanotubes. Diameters of the single-walled carbon nanotubes range from about 0.5 nanometers to about 50 nanometers. Diameters of the double-walled carbon nanotubes range from about 1 nanometer to about 50 nanometers. Diameters of the multi-walled carbon nanotubes range from about 1.5 nanometers to about 50 nanometers.

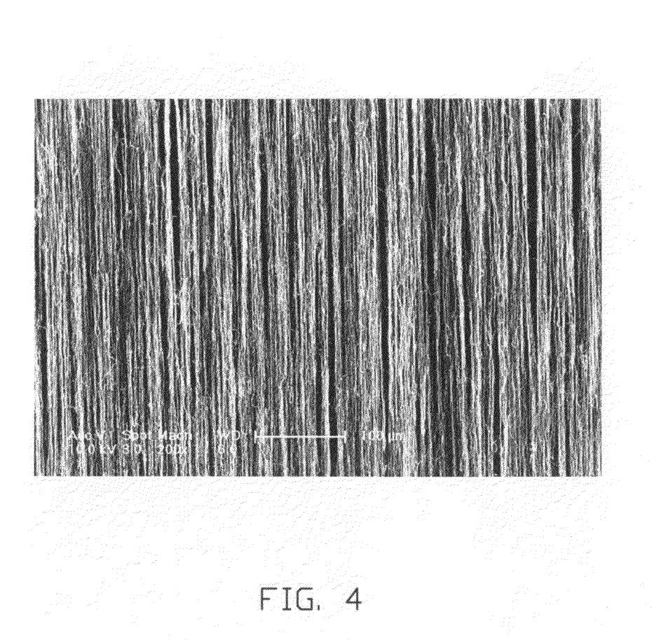

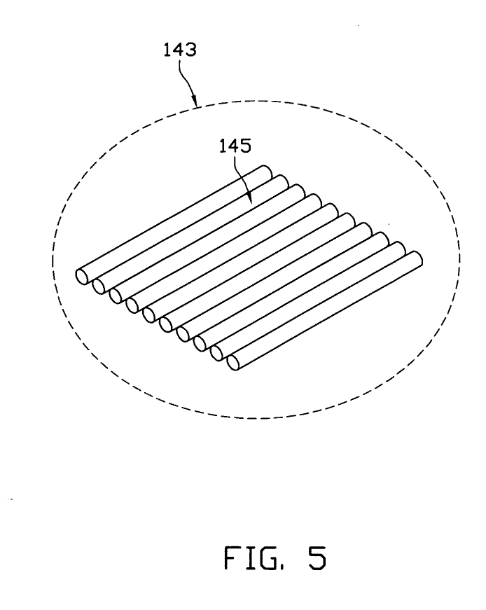

In one embodiment, the ordered film can be a drawn carbon nanotube film. The drawn carbon nanotube film can be formed by drawing from a carbon nanotube array. Referring to FIGS. 4 and 5, the drawn carbon nanotube film can include a plurality of successively oriented carbon nanotube segments 143 joined end-to-end by van der Waals attractive force therebetween. Each carbon nanotube segment 143 includes a plurality of carbon nanotubes 145 parallel to each other, and combined by van der Waals attractive force therebetween. The carbon nanotube segments 143 can vary in width, thickness, uniformity and shape. The carbon nanotubes 145 in the drawn carbon nanotube film 143 are also oriented along a preferred orientation. A length and a width of the drawn carbon nanotube film can be arbitrarily set as desired. A thickness of the drawn carbon nanotube film is in a range from about 0.5 nanometers to about 100 micrometers.

The ordered film also can be a pressed carbon nanotube film. The carbon nanotubes in the pressed carbon nanotube film can be overlapped with each other. The adjacent carbon nanotubes are combined and attracted by van der Waals attractive force, thereby forming a free-standing structure. The pressed carbon nanotube film has two or more sections within each of which the carbon nanotubes are arranged approximately along a same direction (different sections can have different directions). The pressed carbon nanotube film can be formed by pressing a carbon nanotube array formed on a substrate. An angle between a primary alignment direction of the carbon nanotubes and the substrate such that the angle is in a range from 0° to about 15°. The angle is closely related to pressure applied to the carbon nanotube array. The greater the pressure, the smaller the angle. In one embodiment, the carbon nanotubes in the carbon nanotube pressed film can parallel to the surface of the pressed carbon nanotube film when the angle is 0°.

The disordered film can be a flocculated carbon nanotube film. The flocculated carbon nanotube film includes a plurality of carbon nanotubes entangled with each other. A length of the carbon nanotubes can be a few microns to a few hundred microns. The adjacent carbon nanotubes are combined and entangled by van der Waals attractive force therebetween, thereby forming an entangled structure/microporous structure. It is understood that the carbon nanotube film is very microporous. Sizes of the micropores can be less than about 10 micrometers. It can be understood that carbon nanotube structure adopting the flocculated carbon nanotube film having a microporous structure can have a high transparency. Thus it is conducive to use in the touch panel 10.

In the present embodiment, the first transparent conductive layer 122 and the second transparent conductive layer 142 both include a drawn carbon nanotube film. The drawn carbon nanotube film includes a plurality of successive and oriented carbon nanotube segments joined end to end by the van der Waals attractive force therebetween. The carbon nanotubes in the first transparent conductive layer 122 can be oriented along a first direction, and the carbon nanotubes in the second transparent conductive layer 142 can be oriented along a second, different direction. It is to be understood that some variation can occur in the orientation of the nanotubes in the drawn carbon nanotube film as can be seen in FIG. 4. A thickness of the drawn carbon nanotube film ranges from about 0.5 nanometers to about 100 micrometers. A width of the drawn carbon nanotube film ranges from about 0.01 centimeters to about 10 meters.

When the touch panel 10 is installed directly on the display screen 106, the touch panel 10 can further include a shielding layer (not shown) located on the first surface 1402 of the second substrate 140. The material of the shielding layer can be indium tin oxide, antimony tin oxide, carbon nanotube film, or other conductive materials. In the present embodiment, the shielding layer is a carbon nanotube film. The shielding layer carbon nanotube film includes a plurality of carbon nanotubes 145, and the orientation of the carbon nanotubes 145 therein can be arbitrary or arranged along a same direction. The shielding layer is connected to ground and plays a role of shielding and, thus, enables the touch panel 10 to operate without interference (e.g., electromagnetic interference). Further, a passivation layer (not shown) can be further located on a surface of the shielding layer, on the side away from the second substrate 140. The material of the passivation layer can, for example, be silicon nitride or silicon dioxide. The passivation layer can protect the shielding layer 22 from chemical or mechanical damage.

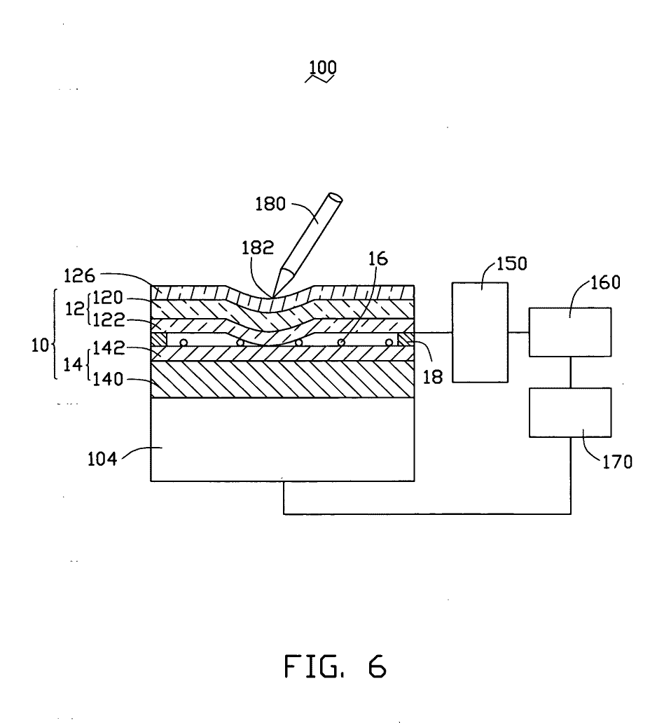

Referring to FIG. 6, in the present embodiment, 5V are applied to each of the two first-electrodes 124 of the first electrode plate 12 and to each of the two second-electrodes 144 of the second electrode plate 14. A user operates the desktop computer 100 by pressing the first electrode plate 12 of the touch panel 10 with a finger, a pen/stylus 180, or the like while visually observing the display screen 106 through the touch panel 10. This pressing causes a deformation of the first electrode plate 12. The deformation of the first electrode plate 12 causes a connection between the first transparent conductive layer 122 and the second conductive layer 142 of the second electrode plate 14. Changes in voltages in the first direction of the first transparent conductive layer 142 and the second direction of the second transparent conductive layer 142 can be detected by the touch panel control element 150. Then the touch panel control element 150 transforms the changes in voltages into coordinates of the touch point 182, and sends the coordinates of the touch point 182 to the CPU 160 in the body 102. The CPU 160 then sends out commands corresponding to the touch point 182 to the display control element 170 and the display control element 170 further controls the display of the display screen 106.

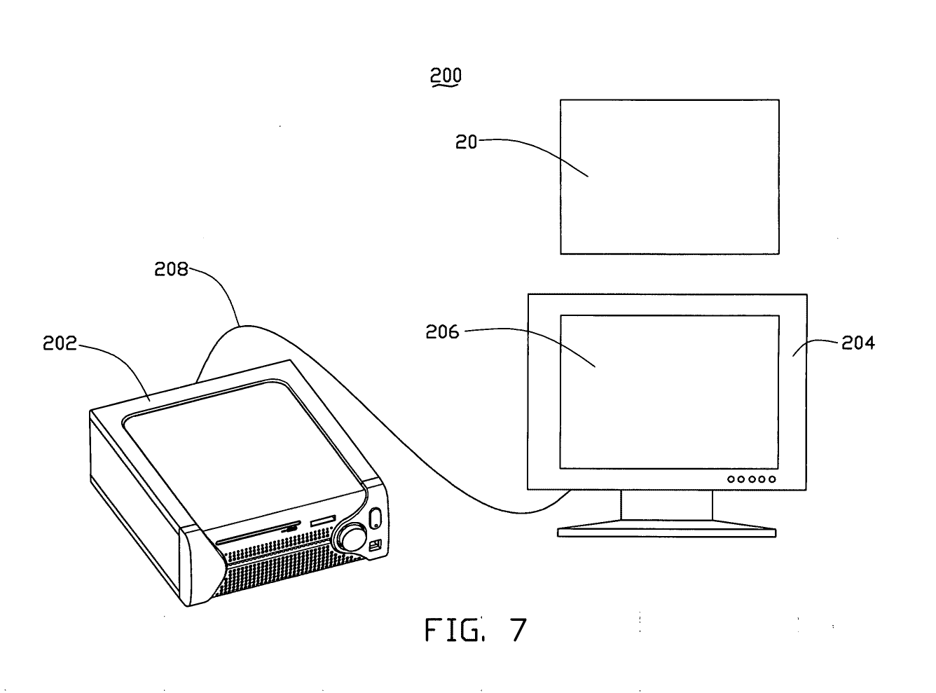

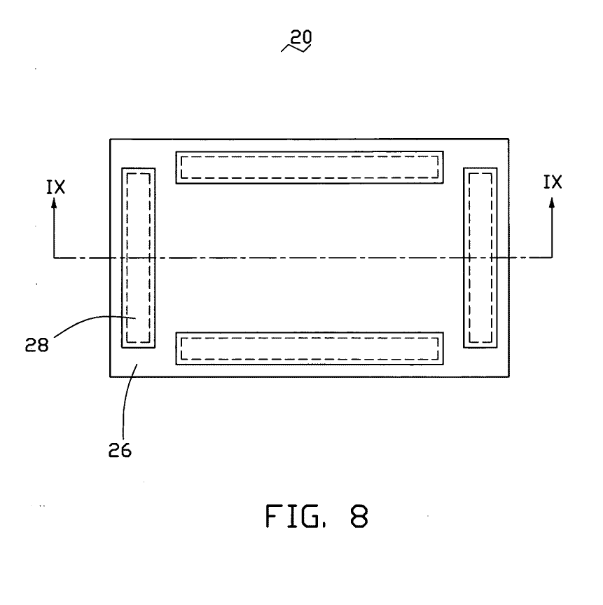

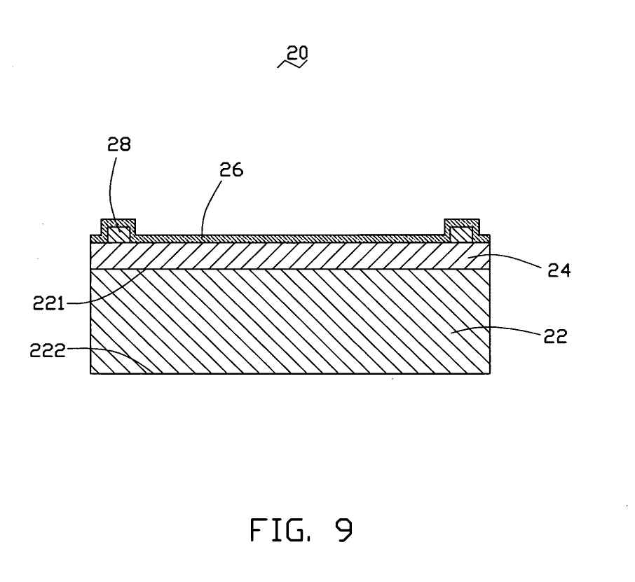

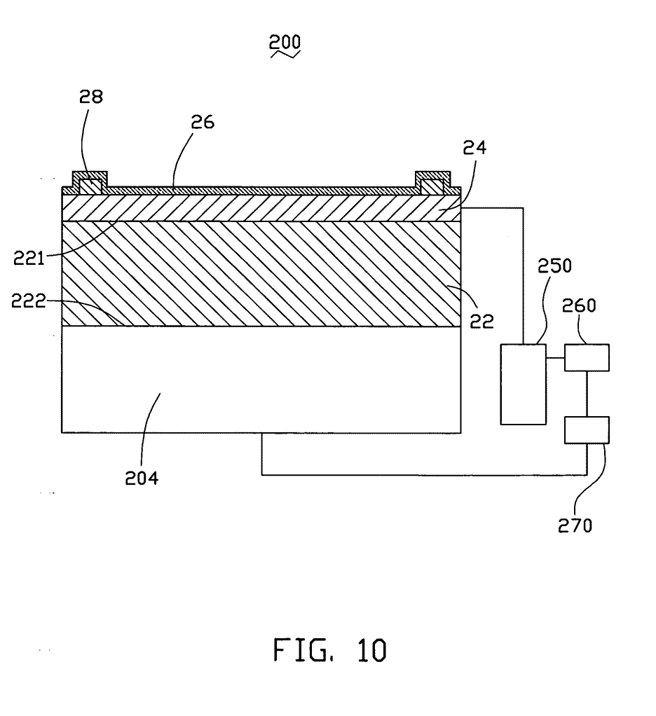

Referring to FIGS. 7 to 10, a desktop computer 200 in accordance with a second embodiment is provided. The desktop computer 200 includes a body 202, a display 204, and a touch panel 20. The display 204 is connected to the body 202 by a data-wire. The display 204 has a display screen 206. The touch panel 20 is adjacent to the display screen 206. In one embodiment, the touch panel 20 is located on the display screen 206.

The body 202 includes a mainboard, a CPU, a memory, and hard drive components, and so on. The mainboard includes a system bus, a data bus, a control bus, a variety of slots and other components. The CPU, memory, graphics cards, sound cards, network cards, video cards are inserted on the mainboard. The hard drive components are electrically connected to the mainboard by a cable. The body 202 further includes a touch panel control element connected with the touch panel and a display control element connected with the display. The touch panel control element and the display control element are electrically connected to the CPU. The CPU accepts the coordinate of a touch point output from the touch panel control element, and processes the coordinates of the touch point. The CPU sends out commands corresponding to the touch point to the display control element and the display control element further controls the display of the display screen 206. At least two of the external input/output ports (not shown) can be located at one terminal of the body 202 and used to connect to the display 204, the touch panel 20 and other devices. Further, a speaker (not labeled) and disk drives (not labeled) can be located on a side of the body 202.

The desktop computer 200 in the second embodiment is similar to the desktop computer 100 in the first embodiment. The difference is that, the touch panel 20 is a capacitance-type touch panel.

The touch panel 20 includes a substrate 22, a transparent conductive layer 24, a transparent protective layer 26, and at least two electrodes 28. The substrate 22 has a first surface 221 and a second surface 222 at opposite sides thereof. The transparent conductive layer 24 is located on the first surface 221 of the substrate 22. The electrodes 28 are located on the same side as the transparent conductive layer 24 and electrically connected with the transparent conductive layer 24 for forming an equipotential surface on the transparent conductive layer 24. The transparent protective layer 26 covers the electrodes 28 and the exposed surface of the transparent conductive layer 24 that faces away from the substrate 22.

The substrate 22 has a planar structure or a curved structure. The material of the substrate 22 can be selected from the group consisting of glass, quartz, diamond, and plastics. Understandably, the substrate 22 is made from a transparent material, e.g., either flexible or stiff, depending on whether a flexible device is desired or not. The substrate 22 is used to support the transparent conductive layer 24. The substrate 22 can be the same as the first substrate 120 or second substrate 140 of the first embodiment.

The transparent conductive layer 24 includes a carbon nanotube structure. The carbon nanotube structure has substantially a uniform thickness and includes a plurality of carbon nanotubes uniformly distributed therein. The carbon nanotubes are orderly or disorderly distributed in the carbon nanotube structure. Specifically, the carbon nanotube structure can be the same as those disclosed in accordance with the first embodiment.

It is to be noted that the shape of the substrate 22 and the transparent conductive layer 24 can be chosen according to the requirements of the touch filed of the touch panel 20. Generally, the shape of the touch filed may be triangular or rectangular, while other shapes can be used. In the present embodiment, the shapes of the touch filed, the substrate 22, and the transparent conductive layer 24 are all rectangular.

Due to the transparent conductive layer 24 being rectangular in the present embodiment, four electrodes 28 are needed and are formed on the surface thereof, thereby obtaining an equipotential surface. The substrate 22 is a glass substrate. The electrodes 28 are strip-shaped and formed of silver, copper, or any alloy of at least one of such metals. The electrodes 28 are located directly on a surface of the transparent conductive layer 24 that faces away from the substrate 22. The electrodes 28 are formed by one or more of spraying, electrical deposition, and electroless deposition methods. Moreover, the electrodes 28 can also be adhered to the surface of the transparent conductive layer 24, e.g., by a silver-based slurry.

Further, in order to prolong operational life span and restrict coupling capacitance of the touch panel 20, the transparent protective layer 26 is located on the electrodes 28 and the transparent conductive layer 24. The material of the transparent protective layer 26 can, e.g., be selected from a group consisting of silicon nitride, silicon dioxide, benzocyclobutenes, polyester film, and polyethylene terephthalate. The transparent protective layer 26 can be a slick plastic film and receive a surface hardening treatment to protect the electrodes 28 and the transparent conductive layer 24 from being scratched when in use.

In the present embodiment, the transparent protective layer 26 is silicon dioxide. The hardness and thickness of the transparent protective layer 26 are selected according to practical needs. The transparent protective layer 26 is adhered to the transparent conductive layer 24, e.g., via an adhesive.

The touch panel 20 can further include a shielding layer 230 located on the second surface 222 of the substrate 22. The material of the shielding layer 230 can be indium tin oxide, antimony tin oxide, carbon nanotube film, and/or another conductive material. In the present embodiment, the shielding layer 230 is a carbon nanotube film. The shielding layer carbon nanotube film includes a plurality of carbon nanotubes, and the orientation of the carbon nanotubes therein may be arbitrarily determined. In the present embodiment, the carbon nanotubes in the shielding layer carbon nanotube film are arranged along a same direction. The shielding layer carbon nanotube film is connected to ground and acts as a shield, thus enabling the touch panel 20 to operate without interference (e.g., electromagnetic interference).

When the shielding layer 230 is located on the second surface 222 of the substrate 22, a passivation layer 232 can be located on and in contact with a surface of the shielding layer 230 that faces away from the substrate 22. The material of the passivation layer 232 can, for example, be silicon nitride or silicon dioxide. The passivation layer 232 can protect the shielding layer 230 from chemical or mechanical damage.

In operation, voltages are applied to the electrodes 28, by the touch panel control element 250. A user operates the desktop computer 200 by pressing or touching the transparent protective layer 26 of the touch panel 20 with a touch tool (not shown), such as a finger, or an electrical pen/stylus, while visually observing the display screen 206 through the touch panel 20. Due to an electrical filed of the user, a coupling capacitance forms between the user and the transparent conductive layer 24. For high frequency electrical current, the coupling capacitance is a conductor, and thus the touch tool takes away a little current from the touch point. Currents flowing through the four electrodes 28 cooperatively replace the current lost at the touch point. The quantity of current supplied by each electrode 28 is directly proportional to the distances from the touch point to the electrodes 28. The touch panel control element 250 is used to calculate the proportion of the four supplied currents, thereby detecting coordinates of the touch point on the touch panel 20. Then, the touch panel control unit 250 sends the coordinates of the touch point to the CPU 260. The CPU 160 then sends out commands corresponding to the touch point to the display control element 270 and the display control element 270 further controls the display of the display screen 206.

The desktop computer employing the carbon nanotube film has a high transparency, thereby promoting improved display brightness.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A desktop computer, comprising:
a body;
a display connected to the body via a data wire, the display comprising a display screen; and
a touch panel, the touch panel comprising at least one transparent conductive layer comprising a carbon nanotube structure.

2. The desktop computer of claim 1, wherein the carbon nanotube structure comprises a plurality of carbon nanotubes uniformly distributed therein.

3. The desktop computer of claim 1, wherein the carbon nanotube structure comprises of an ordered carbon nanotube film.

4. The desktop computer of claim 3, wherein the carbon nanotube film comprises of a plurality of carbon nanotubes primarily arranged along a single direction.

5. The desktop computer of claim 3, wherein the carbon nanotube film comprises of two or more sections within each of which the carbon nanotubes are arranged approximately along a same direction.

6. The desktop computer of claim 2, wherein the carbon nanotubes film comprises of carbon nanotubes that are disorderly arranged, and the carbon nanotubes are entangled or attracted to each other by van der Waals attractive force therebetween.

7. The desktop computer of claim 1, wherein the carbon nanotube structure comprises at least one carbon nanotube film comprising a plurality of successively oriented carbon nanotube segments joined end to end by the van der Waals attractive force therebetween, each carbon nanotube segment comprises a plurality of the carbon nanotubes that are combined by van der Waals attractive force therebetween.

8. The desktop computer of claim 7, wherein the carbon nanotube structure comprises at least two carbon nanotube films, an angle between the aligned directions of the carbon nanotubes in the two adjacent carbon nanotube films ranges from greater than or equal to 0 degrees to less than or equal to 90 degrees.

9. The desktop computer of claim 1, wherein the touch panel is adjacent to the display screen.

10. The desktop computer of claim 9, wherein the touch panel is located on a surface of the display screen.

11. The desktop computer of claim 1, further comprising a base, the touch panel and the display screen are integrated with the base.

12. The desktop computer of claim 1, wherein the touch panel is a capacitance-type touch panel, and comprises:
a substrate adjacent to the display screen;
a transparent conductive layer located on the substrate, the transparent conductive layer comprises of the carbon nanotube structure; and
two electrodes electrically connected to the transparent conductive layer.

13. The desktop computer of claim 12, wherein the two electrodes comprise of a carbon nanotube film or a conductive metal layer.

14. The desktop computer of claim 1, wherein the touch panel is a resistance-type touch panel, and comprises:
a first electrode plate comprising:
a first substrate,
a first transparent conductive layer located on a first surface of the first substrate, the first transparent conductive layer comprises of the carbon nanotube structure, the carbon nanotube structure comprises a plurality of carbon nanotubes arranged primarily along a first direction, and
two first electrodes that are connected to the first transparent conductive layer; and
a second electrode plate separated from the first electrode plate, and comprising:
a second substrate located adjacent to the display screen;
a second transparent conductive layer located on the second substrate opposite to the first surface; the second transparent conductive layer comprises of the carbon nanotube structure, the carbon nanotube structure comprises a plurality of carbon nanotubes arranged primarily along a second direction, the first direction being perpendicular to the second direction; and
two second electrodes that are electrically connected to the second transparent conductive layer.

15. The desktop computer of claim 14, wherein the touch panel further comprises an insulative layer located between the first and second electrode plates for insulating the first electrode plate from the second electrode plate.

16. The desktop computer of claim 14, wherein one or more of dot spacers are located between the first transparent conductive layer and the second transparent conductive layer.

17. The desktop computer of claim 14, wherein the touch panel further comprises a transparent protective film located on the first substrate.

18. The desktop computer of claim 14, wherein the touch panel further comprises a shielding layer and a passivation layer located between the second electrode plate and the display screen, the passivation layer is located between the shielding layer and the display screen.

19. The desktop computer of claim 1, wherein the display screen is selected from a group consisting of liquid crystal display screen, filed emission display screen, plasma display screen, electroluminescent display screen and vacuum fluorescent display screen.

20. The desktop computer of claim 1, wherein the body further comprises a main board, a central processing unit, a memory, and hard drive components.
